(19) United States
(12) Patent Application Publication
(10) Pub. No.: US 2011/0024570 A1
(43) Pub. Date: Feb. 3, 2011

(54) DEVICE FOR LOCATION OF MAIN CANOPY FROM A PARACHUTE

(76) Inventors: Erico Ajace Theodorovitz, São Paulo (BR); Rodrigo Selva Queiroz, São Paulo (BR)

Correspondence Address: ANDERSON TMP , INC, 1903 60 TH PLACE E, SUITE M5103, BRADENTON, FL, 34203, US

(21) Appl. No.: 12/936,724

(22) PCT Filed: Apr. 14, 2009
(86) PCT No.: PCT/BR2009/000103

§ 371 Date: Oct. 7, 2010

(30) Foreign Application Priority Data
Apr. 15, 2008 (BR) PI0801952-5

(51) Int. Cl. B64D 17/38

(52) U.S. Cl. 244/151 B

(57) ABSTRACT

“DEVICE FOR LOCATION OF MAIN CANOPY FROM A PARACHUTE”, which is indicated by reference (DLC) and wherein consists on a circuitry (1), which is essentially defined by a switch (2) formed by positive (3) and negative (4) contacts, said switch (2) is connected between a battery (5) and a GPS module (6), including a reception antenna (7) through which it received the positioning signals of orbit satellites; said switch (2) is simultaneously connected to a transmitter module of radio frequency (8) receiving location coordinates sent by the GPS module (6) and transmitting through a transmitting antenna (8A); circuitry (1) is housed in a covering or body (9) produced in plastic material or other appropriate material, which has an opening (10), though which it is inserted the end of a flexible stem (11) produced in isolating material, and has as a function to maintain away the electric contacts (3) and (4) so that the circuitry (1) is usually inoperative; flexible cable (11) includes a slightly sharp end (12), which allows the separation of electric contacts (3) and (4) at the time of its introduction between said contacts; flexible cable (11) also includes a periphery shoulder (13) assuring an optimal condition of immobilization of said flexible cable (11) in relation to electric contacts (3) and (4).

The present patent of Invention Privilege deals with a device developed especially to allow the location of the main canopy from a parachute, after said canopy have been disconnected by the parachutist as a result of the need to use the reserve parachute (reserve canopy), in a emergency situation.

Parachuting in its original days initially was used by military units only, in disembarkation operations for assault troops or congeners, but with time it has become popular, being used for some time also as a way of sports, which counts with a series of modalities.

As is general knowledge, parachuting consists of a practice which foresees the jump of an individual from an airplane (or, in more recent terms, from a fixed base, such as a natural elevation or artificial structure, etc.), the same being equipped with a parachute, equipment which briefly consists of a main parachute (main canopy) and one reserve parachute, both packaged in a structure analogous to a knapsack, which is fixed to the back of the player by means of a series of straps interconnected to a belt.

Both the main and the reserve canopy are connected to the set of straps and belt by means of a plurality of cables or shafts, when being stretched in the opening time, distributes the load of the parachutist in relation to the total area of the canopy being in use.

The parachute itself is an article developed to confer the user an raised level of safety and as such counts with a reserve canopy which is used in emergency situations, whenever the main canopy presents problems in its opening, twists or by any reason has to be released (disconnected).

The release or disconnection of the main canopy is an operation which is controlled by the parachutist through operation of a specific lever integrated with the set of straps and belt, and when said lever is pulled, it is controlled a pair of par of disarming cables simultaneously crossing two sequential mountings of rings from different sizes and corresponding mounting eyes of said rings, being one mounting of rings for each shaft of the main parachute.

In each one of the shafts of the main parachute, the rings are mounted to connect themselves sequentially, and wherein, as of a metallic hoop incorporated to the straps which fasten the parachute to the user's body, is crossed a first tissue eye which has in its end a ring with smaller diameter than the diameter of the metallic hoop. This ring after crossing the metallic hoop is connected to another tissue eye, which has in its end a corresponding metallic ring with smaller diameter than the diameter of the first ring. This second metallic ring, after crossing the previous tissue eye is crossed by one more tissue eye crossing a terminal band and is clamped in the corresponding disarm cable.

Thus, when the disarm cable crosses the first tissue eye attached to it, causes a sequential release of other rings and its respective tissue eyes, causing at last the crossing of the first ring inside the metallic hoop with consequent release of shafts connecting to the main parachute to the rest of the equipment.

The connection system described above allows the connection of the main canopy to the set of straps and belt to occur for the system to “disarm” with relative simplicity by means of the withdraw of disarm cables from its mounting location in relation to the tissue eye and, on the other hand, by the type of project adopted, avoiding accidental disconnection of the main canopy.

In practice, the release or disconnection of the main canopy, in addition to the disturbance represented by the need to use the reserve parachute, it represents, to the parachutist, the certainty that even after landing, it will also demand a search of the main canopy, since it is, when released, invariably carried by the wind currents predominant in the jumping location. In a more objective way, the main canopy, after being release, effectively may be carried by the wind to several kilometers away from the landing location of the parachutist.

Almost always, the parachutist which is forced to disconnect its main canopy almost exclusively depends on the cooperation of the parachutists, in land, which jointly are in charge to search the canopy released, or at least try to see its course, and a search to approximately identify its falling location, mentioning such information to the owner thereof.

It is worth mentioning that the main canopy is an item corresponding to a great percentage of the total value from a parachute, and its loss represents a great damage to the parachutist.

In regard to the state of art described above, one of the purposes of this patent of Invention Privilege is characterized by proposing a device for location of the main canopy from a parachute, which provides an electronic device incorporated to the main canopy and which automatically can be actuated at the time of the disconnection thereof.

The electronic device presented herein may include one GPS unit, which can send through a transmitter the coordinates of the location thereof; a device for GSM transmission, acting in regard to emit a location signal detectable by a radio frequency device emitting a signal in certain frequency, which signal also can be traced by an appropriate equipment.

The device for location of the main canopy from a parachute, purpose of this patent of Invention Privilege may be understood in all its constructive and functional respects as of the detailed description, which will be made based on the figures related below, in which:

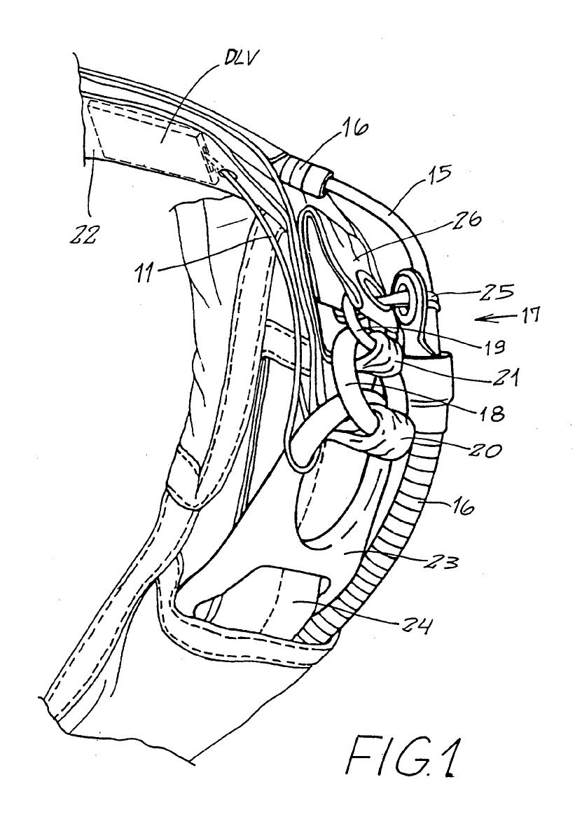

FIG. 1 illustrates one of the two mountings connecting the wire of the main canopy (main parachute) to the parachute itself, wherein, in dashed line, may be observed the proposed device;

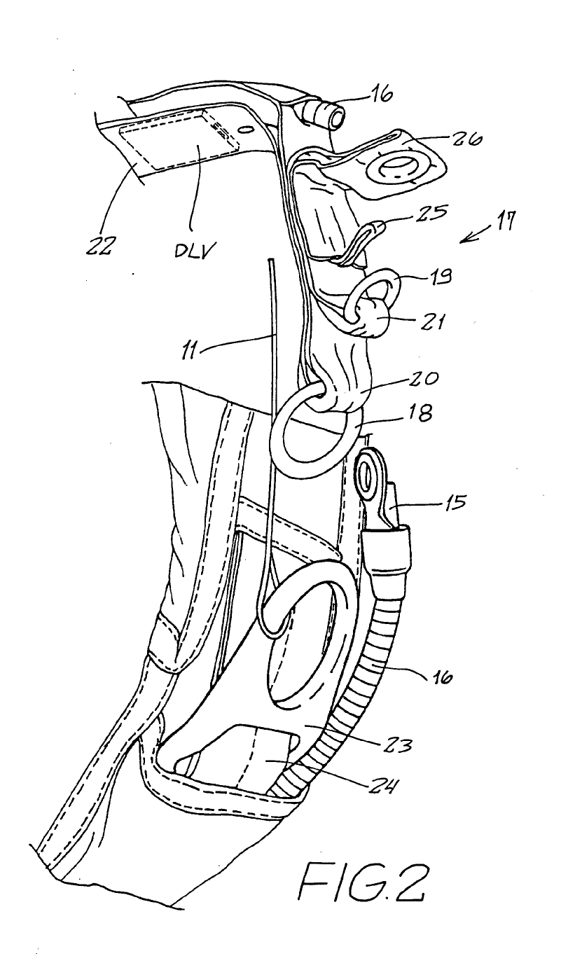

FIG. 2 also illustrates one of two mountings connecting the wire of the main canopy (main parachute) to the parachute itself, said mounting is specifically seen at the time in which a disconnection is directed of said main canopy and commences the sending of reference signal for location of the device proposed herein;

FIG. 3 illustrates one schematic view of constructive diagram from the device described herein, which is seen in its inoperative condition;

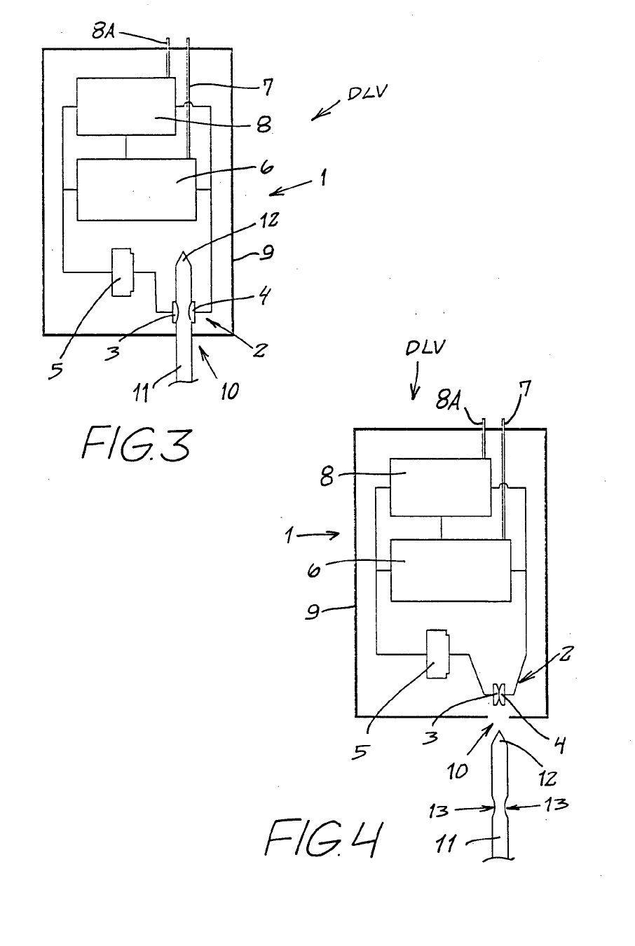

FIG. 4 illustrates one schematic view of the constructive diagram from the device seen in FIG. 3, wherein it is specifically seen at the time it starts operation as a result of disconnection of the main canopy;

FIG. 5 illustrates one variant of the device seen in FIGS. 3 and 4, wherein its actuation occurs by means of separation of a magnetic terminal, said variant is seen in its inoperative condition;

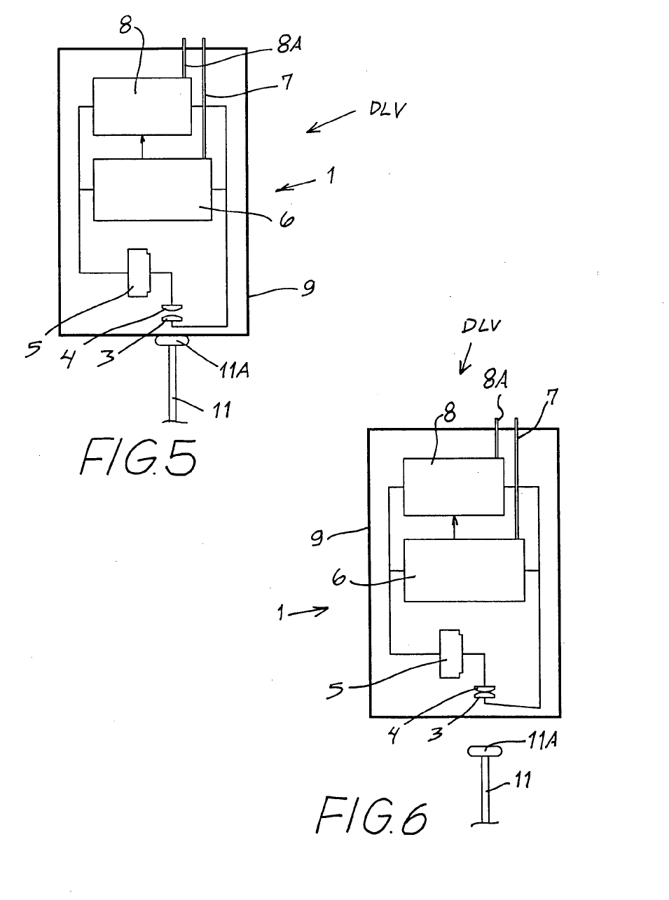

FIG. 6 illustrates the variant seen in FIG. 5, wherein it is seen the time in which the device starts operation as a result of disconnection of the main canopy, said variants has a gps module for sending geographic coordinates allowing the location of the main canopy after the disconnection thereof; and

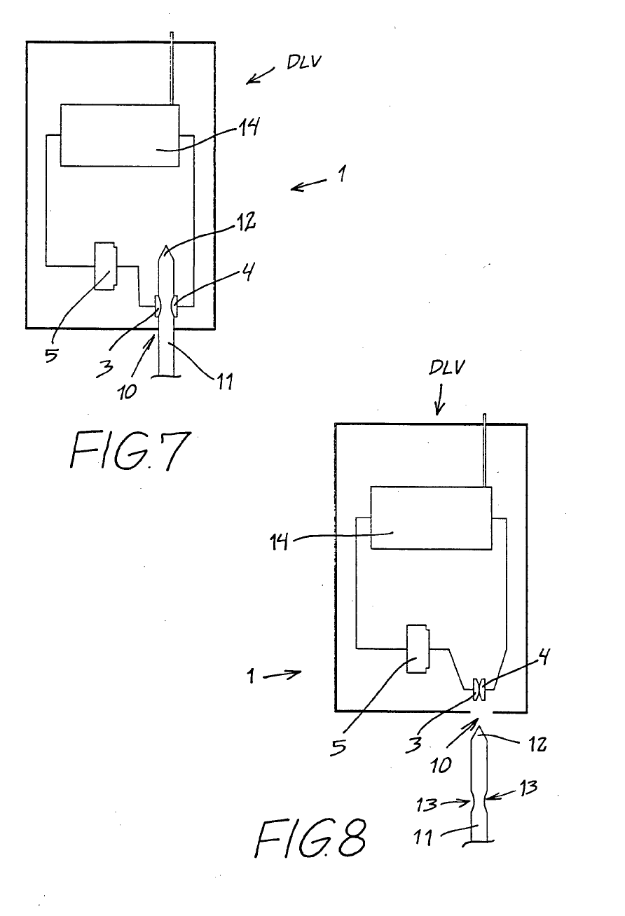

FIGS. 7 and 8 illustrate another constructive variant of the proposed device, which differently from previous ones has a transmitter module of radio frequency for sending signals allowing the location of the main canopy.

In accordance with what it is illustrated in the figures related above, the device for location of the main canopy from a parachute is indicated by the reference DLC (that is, device for location of the canopy) consists on a circuitry 1, which is essentially defined by a switch 2 formed by positive 3 and negative 4 contacts (both mobile), said switch 2 is connected between a battery 5 and a GPS module 6, including a reception antenna 7 through which it receives positioning signals of orbit satellites.

Said switch 2 is simultaneously connected to a transmitter module of radio frequency 8 receiving location coordinates sent by the GPS module 6 and transmit them through a transmitting antenna 8A.

Circuitry 1 described herein is packaged in a covering or body 9 produced in plastic material or other appropriate material, which has an opening 10, through which it is inserted the end of a flexible stem 11 produced in isolating material, and which has as a function to maintain apart the electric contacts 3 and 4 so that the circuitry 1 is usually inoperative.

The flexible cable 11 may be produced in plastic material or other being appropriate and includes a slightly sharp end 12, allowing the separation of the electric contacts 3 and 4 at the time of its introduction between said contacts.

The flexible cable 11 also includes a periphery shoulder 13 assuring an optimal condition of immobilization for said flexible cable 11 in relation to electric contacts 3 and 4.

FIGS. 3 and 4 illustrate the proposed device in two conditions, that is, inoperative (FIG. 3) and operative (FIG. 4).

FIGS. 5 and 6 illustrate a variant of the present device, which operates in the same manner as the device seen in FIGS. 3 and 4, however, being different in the actuation manner operating over the electric contacts 3 and 4.

In the version of FIGS. 5 and 6, one flexible cable 11 incorporated a permanent magnet 11A, it being able to magnetically attract the mobile electric contact 4, maintaining it away from the mobile electric contact 3.

In a manner analogous to the one seen in the first variant, when the flexible cable 11 is moved (stressed), it is determined the closing of the switch 2, in this case, which operation occurs through the approximation of the mobile contact 3 toward the fixed contact 4.

FIGS. 7 and 8 illustrate another constructive variant of the proposed device, which has, differently from the previous ones, a transmitter module of radio frequency 14, produced to emit a signal in previous established frequency, whose signal can be received by a duly adjusted receiver for such operation.

The systematic of the device operation described herein can be better understood when in conjunction being taken into consideration the FIGS. 1 and 2, wherein the device itself is seen already incorporated to the parachute mounting.

Such as already said, the release or disconnection of the main canopy is an operation controlled by the parachutist through the actuation of a specific lever (not shown), which is integrated to the set of straps and belt of the parachute, and when pulled, said lever controls a pair of disarm cables 15 (one of which is seen in FIGS. 1 and 2) crossing inside a flexible conduit 16 and simultaneously cross two sequential mountings 17 of rings 18 and 19 from different sizes and corresponding mounting eyes 20 and 21 of such rings, being one mounting of rings 17 for each one of two shafts 22 of the main parachute (not shown), and inside one of such shafts 22 it is mounted the device itself, such as can be schematically seen in said FIGS. 1 and 2.

Also with regard to FIGS. 1 and 2, it can be seen that the mounting 17 actually starts in a hoop 23 fixedly mounted in the handle 24.

Specifically in relation to the systematic of actuation for the device described herein, it can be seen that the flexible cable 11 is crossing around the hoop 23 before finding the device already housed in said wire 22.

The mounting above provides that the rings be mounted for them to sequentially connect, and wherein, as of the metallic hoop 23 incorporated to the handles fastening the parachute to the user's body, is crossed the first tissue eye 20, having in its end the ring 18 with smaller diameter than the diameter of the metallic hoop. The ring 18, after crossing the metallic hoop 23 is connected to another tissue eye 21, which has in the end thereof a corresponding metallic ring 19, with smaller diameter than the diameter of the first ring 18. This second metallic ring 19 is crossed by another tissue eye 25, which crosses a terminal band 26 and is clamped in the corresponding disarm cable 15.

When the disarm cable 15 crosses the tissue eye 25 attached to it, causes sequential release of other rings and its respective tissue eyes, causing at last the crossing of the first ring inside the metallic hoop with consequent release of the shafts 22 connecting the main parachute to the rest of the equipment.

As the flexible cable 11 is attached to the hoop 23, at the time of separation (disconnection) of the main canopy, it also occurs withdraw of said flexible cable 11 of its housing inside the device, which fact causes the switch 2 to close, thus actuating the device.

The working systematic described above is the same for each one of the variants of the present device, that is, separation of the main canopy as a result of the operation of corresponding lever, determines the actuation of the present device, thus allowing the location of the canopy to which it is incorporated.

Although not illustrated, there is a forecast that the present device may incorporate a proximity sensor allowing the detection of the disconnection condition of the main canopy, having yet another option with the on-off key.

1. “DEVICE FOR LOCATION OF MAIN CANOPY FROM A PARACHUTE”, which is indicated by reference (DLC) and wherein consists on a circuitry (1), which is essentially defined by a switch (2) formed by positive (3) and negative (4) contacts, said switch (2) is connected between a battery (5) and a GPS module (6), including a reception antenna (7) through which it received the positioning signals of orbit satellites; said switch (2) is simultaneously connected to a transmitter module of radio frequency (8) receiving location coordinates sent by the GPS module (6) and transmitting through a transmitting antenna (8A); circuitry (1) is housed in a covering or body (9) produced in plastic material or other appropriate material, which has an opening (10), though which it is inserted the end of a flexible stem (11) produced in isolating material, and has as a function to maintain away the electric contacts (3) and (4) so that the circuitry (1) is usually inoperative; flexible cable (11) includes a slightly sharp end (12), which allows the separation of electric contacts (3) and (4) at the time of its introduction between said contacts; flexible cable (11) also includes a periphery shoulder (13) assuring an optimal condition of immobilization of said flexible cable (11) in relation to electric contacts (3) and (4).

2. “DEVICE FOR LOCATION OF MAIN CANOPY FROM A PARACHUTE”, according to claim 1, wherein, in a constructive variant, the device (DLC) provides the use of a flexible cable (11) incorporating a permanent magnet (11A), and this is able to magnetically attract the mobile electric contact (4), maintaining it separated from the mobile electric contact (3), and the flexible cable (11) mounted for crossing around the hoop (23) which is fixedly attached to corresponding handle (24) from one of two handles (24) integrating a parachute; the device (DLC) being mounted inside one of two shafts (22) of the parachute.

3. “DEVICE FOR LOCATION OF MAIN CANOPY FROM A PARACHUTE”, according to claim 1, wherein, in another constructive variant, the proposed device (DLC) has a transmitter module of radio frequency (14), produced to emit a signal in a previously established frequency, which signal may be received by a duly adjusted receiver for such operation.

4. “DEVICE FOR LOCATION OF MAIN CANOPY FROM A PARACHUTE”, according to claim 1, wherein at the time of disconnection of the main canopy from the parachute, the flexible cable (11) is removed or separated from the device (DLC) thus, determining its actuation.

5. “DEVICE FOR LOCATION OF MAIN CANOPY FROM A PARACHUTE”, according to claim 1, wherein the device (DLC) has a proximity sensor.

6. “DEVICE FOR LOCATION OF MAIN CANOPY FROM A PARACHUTE”, according to claim 1, wherein the device (DLC) is operated with an on-off device.
